(19) United States
(12) Patent Application Publication
(10) Pub. No.: US 2025/0138312 A1
(43) Pub. Date: May 1, 2025

(54) DISPLAY DEVICE AND HEAD-UP DISPLAY

(71) Applicant: Japan Display Inc., Tokyo (JP)

(72) Inventors: Kazunari TOMIZAWA, Tokyo (JP); Chikyu NAKAOKA, Tokyo (JP); Takeo KOITO, Tokyo (JP); Yuta HAGA, Tokyo (JP)

(21) Appl. No.: 18/925,431

(22) Filed: Oct. 24, 2024

(30) Foreign Application Priority Data
Oct. 26, 2023 (JP) 2023-183763

(51) Int. Cl. G02B 27/01

(52) U.S. Cl. CPC G02B 27/0101

(57) ABSTRACT

According to an aspect, a display device includes: a backlight, first and second image display panels. The first image display panel includes: a first polarizing plate configured to transmit light polarized in a first direction and block light polarized in a direction different from the first direction; and a first color filter provided between the first polarizing plate and the second image display panel. The second image display panel includes: a second polarizing plate configured to transmit light polarized in a second direction and block light polarized in a direction different from the second direction; and a second color filter provided between at least the second polarizing plate and the first image display panel. The thickness of the first color filter is different from the thickness of the second color filter. Another polarizing plate is not provided between the first image display panel and the second image display panel.

### CROSS-REFERENCE TO RELATED APPLICATION

This application claims the benefit of priority from Japanese Patent Application No. 2023-183763 filed on Oct. 26, 2023, the entire contents of which are incorporated herein by reference.

### BACKGROUND

### 1. Technical Field

What is disclosed herein relates to a display device and a head-up display.

### 2. Description of the Related Art

Widely known are head-up displays (HUDs) that project an image onto a light-transmitting member, such as glass, to allow the image reflected by the light-transmitting member to be visually recognized as a virtual image by a viewer (e.g., Japanese Patent Application Laid-open Publication No. 2004-168230 (JP-A-2004-168230)).

In such a HUD, the spatial position of the virtual image visually recognized by the viewer depends on relative positions between a display panel, a reflective member, and the point of view of the viewer. Specifically, the distance from the point of view of the viewer to the virtual image increases as the distance between the display panel and the reflective member increases, and the distance from the point of view of the viewer to the virtual image decreases as the distance between the display panel and the reflective member decreases. In JP-A-2004-168230, a plurality of display panels are stacked in a manner vertically spaced apart from each other and display different output images, whereby the distances from the point of view of the viewer to the virtual images of the respective output images displayed by the display panels are different from one another.

In the conventional technology described above, the display regions of the respective display panels are arranged such that they do not overlap when viewed in the direction of the line of sight of the observer. Therefore, images with different distances from the point of view of the viewer to the virtual image may possibly be failed to be positioned freely based on the point of view of the viewer. In the conventional technology described above, if the display regions of the respective display panels are arranged in a manner overlapping each other, the quantity of transmitted light may possibly be significantly reduced.

For the foregoing reasons, there is a need for a display device and a head-up display that can reduce the decrease in the quantity of transmitted light.

### SUMMARY

According to an aspect, a display device includes: a backlight; a first image display panel configured to receive direct light from the backlight; and a second image display panel disposed with a gap interposed between the second image display panel and the first image display panel and configured to receive light transmitted through the first image display panel. The first image display panel includes: a first polarizing plate configured to transmit light polarized in a first direction and block light polarized in a direction different from the first direction; and a first color filter provided between at least the first polarizing plate and the second image display panel. The second image display panel includes: a second polarizing plate configured to transmit light polarized in a second direction different from the first direction and block light polarized in a direction different from the second direction; and a second color filter provided between at least the second polarizing plate and the first image display panel. The thickness of the first color filter is different from the thickness of the second color filter. Another polarizing plate is not provided between the first image display panel and the second image display panel.

According to an aspect, a head-up display is configured to allow an image reflected by a light-transmitting member configured to transmit and reflect incident light to be visually recognized as a virtual image by a viewer such that the virtual image is superimposed on a real image transmitted through the light-transmitting member. The head-up display includes: the display device; and a magnifying optical system configured to magnify an image displayed on the display device and project the magnified image onto the light-transmitting member.

### BRIEF DESCRIPTION OF THE DRAWINGS

FIG. 1 is a schematic diagram of a head-up display that is an example of applications of a display device according to an embodiment;

FIG. 2A is a schematic diagram of the basic configuration of the HUD;

FIG. 2B is a schematic diagram of an equivalent configuration of the HUD illustrated in FIG. 2A;

FIG. 3 is a graph of the relation between the distance between a panel and a lens, and a virtual distance between a point of view and a virtual image;

FIG. 4 is a schematic diagram of an equivalent configuration of the HUD;

FIG. 5 is a schematic diagram of a detailed configuration of the display device according to the embodiment;

FIG. 6A is a diagram illustrating a first example of a display form of the HUD in which the display device according to the embodiment is used;

FIG. 6B is a diagram of a first object visually recognized in a virtual image of a first image in the display form illustrated in FIG. 6A;

FIG. 6C is a diagram of a second object visually recognized in a virtual image of a second image in the display form illustrated in FIG. 6A;

FIG. 6D is a sectional view of the display device illustrated in FIG. 6A along line A-A;

FIG. 7A is a diagram illustrating a second example of the display form of the HUD in which the display device according to the embodiment is used;

FIG. 7B is a diagram of the first object visually recognized in the virtual image of the first image in the display form illustrated in FIG. 7A;

FIG. 7C is a diagram of the second object visually recognized in the virtual image of the second image in the display form illustrated in FIG. 7A;

FIG. 7D is a sectional view of the display device illustrated in FIG. 7A along line A-A;

FIG. 8 is a diagram conceptually illustrating a state where the second image is displayed on a second image display panel in the display device according to a comparative example;

FIG. 9 is a graph of an example of the emission spectrum of a backlight;

FIG. 10 is a graph of an example of the spectral transmittance of a first color filter and a second color filter in the display device according to the comparative example;

FIG. 11 is a graph of an example of the transmitted light spectrum of the first color filter and the incident light spectrum of the second color filter in the display device according to the comparative example;

FIG. 12 is a schematic diagram of an example of the color gamut of the second image when the second image is displayed on the second image display panel in the display device according to the comparative example;

FIG. 13 is a diagram conceptually illustrating a state where the first image is displayed on a first image display panel in the display device according to the comparative example;

FIG. 14 is a graph of an example of the transmitted light spectrum of the first color filter and the incident light spectrum of the second color filter in the display device according to the comparative example;

FIG. 15 is a schematic diagram of an example of the color gamut of the first image when the first image is displayed on the first image display panel in the display device according to the comparative example;

FIG. 16 is a diagram conceptually illustrating a state where the second image is displayed on the second image display panel in the display device according to a first embodiment;

FIG. 17 is a graph of an example of the spectral transmittance of the first color filter and the second color filter in the display device according to the first embodiment;

FIG. 18 is a graph of an example of the transmitted light spectrum of the first color filter and the incident light spectrum of the second color filter in the display device according to the first embodiment;

FIG. 19 is a schematic diagram of an example of the color gamut of the second image when the second image is displayed on the second image display panel in the display device according to the first embodiment;

FIG. 20 is a diagram conceptually illustrating a state where the first image is displayed on the first image display panel in the display device according to the first embodiment;

FIG. 21 is a graph of an example of the transmitted light spectrum of the first color filter in the display device according to the first embodiment;

FIG. 22 is a schematic diagram of an example of the color gamut of the first image when the first image is displayed on the first image display panel in the display device according to the first embodiment;

FIG. 23 is a diagram conceptually illustrating a state where the second image is displayed on the second image display panel in the display device according to a second embodiment;

FIG. 24 is a graph of an example of the spectral transmittance of the first color filter and the second color filter in the display device according to the second embodiment;

FIG. 25 is a graph of an example of the transmitted light spectrum of the first color filter and the incident light spectrum of the second color filter in the display device according to the second embodiment;

FIG. 26 is a schematic diagram of an example of the color gamut of the second image when the second image is displayed on the second image display panel in the display device according to the second embodiment;

FIG. 27 is a diagram conceptually illustrating a state where the first image is displayed on the first image display panel in the display device according to the second embodiment;

FIG. 28 is a graph of an example of the transmitted light spectrum of the first color filter in the display device according to the second embodiment;

FIG. 29 is a schematic diagram of an example of the color gamut of the first image when the first image is displayed on the first image display panel in the display device according to the second embodiment;

FIG. 30 is a first schematic diagram for comparing the color gamut of the display device according to the first embodiment with that of the display device according to the second embodiment; and

FIG. 31 is a second schematic diagram for comparing the color gamut of the display device according to the first embodiment with that of the display device according to the second embodiment.

### DETAILED DESCRIPTION

Exemplary aspects (embodiments) to embody the present disclosure are described below in greater detail with reference to the accompanying drawings. The contents described in the embodiments below are not intended to limit the present disclosure. Components described below include components easily conceivable by those skilled in the art and components substantially identical therewith. Furthermore, the components described below may be appropriately combined. What is disclosed herein is given by way of example only, and appropriate modifications made without departing from the spirit of the disclosure and easily conceivable by those skilled in the art naturally fall within the scope of the present disclosure. To simplify the explanation, the drawings may possibly illustrate the width, the thickness, the shape, and other elements of each unit more schematically than the actual aspect. These elements, however, are given by way of example only and are not intended to limit interpretation of the present disclosure. In the present specification and the figures, components similar to those previously described with reference to previous figures are denoted by the same reference numerals, and detailed explanation thereof may be appropriately omitted.

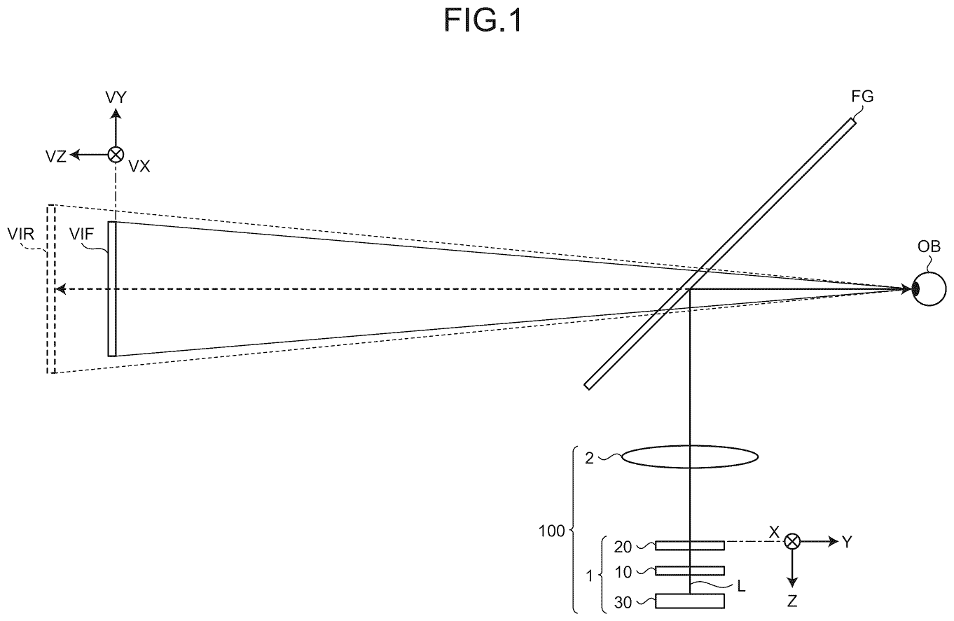

FIG. 1 is a schematic diagram of a head-up display that is an example of applications of a display device according to an embodiment. A head-up display (hereinafter referred to simply as “HUD”) 100 includes a display device 1 and a magnifying optical system 2 that magnifies an image displayed on the display device 1 and projects it onto a light-transmitting member FG.

The light-transmitting member FG is a member with a light-transmitting property, such as glass and resin. Examples of the light-transmitting member FG include, but are not limited to, vehicle windshields, combiners, etc. The light-transmitting member FG may be any member that transmits and reflects incident light and is not limited to vehicle windshields or combiners.

The magnifying optical system 2 is, for example, a lens. The magnifying optical system 2 is not limited thereto, and one magnifying optical system 2 may be composed of a plurality of optical members, such as a plane mirror and a concave mirror.

The display device 1 includes a first image display panel 10 that displays a first image, a second image display panel 20 that displays a second image, and a backlight 30 as main components.

The backlight 30 outputs planar light (light L) toward the first image display panel 10. The light L output from the backlight 30 is transmitted through the first image display panel 10, the second image display panel 20, and the magnifying optical system 2 in this order as indicated by the solid arrow in FIG. 1 and is reflected by the light-transmitting member FG to reach the point of view of an observer (viewer) OB. An image output region of the first image display panel 10 and an image output region of the second image display panel 20 overlap when viewed in the optical axis direction of the magnifying optical system. In other words, the image output region of the first image display panel 10 and the image output region of the second image display panel 20 overlap when viewed in the line-of-sight direction in which the images of the display device 1 reflected by the light-transmitting member FG is viewed from the point of view of the viewer OB. Therefore, a virtual image VIR of the first image and a virtual image VIF of the second image reflected by the light-transmitting member FG are visually recognized by the viewer OB in such a manner that the virtual images are superimposed on each other in the direction indicated by the dashed arrow in FIG. 1.

In the following description, the virtual distance from the point of view of the viewer OB to the virtual image VIR of the first image reflected by the light-transmitting member FG and to the virtual image VIF of the second image reflected by the light-transmitting member FG is also referred to simply as a “virtual distance”. The virtual position of each of the virtual image VIR of the first image reflected by the light-transmitting member FG and the virtual image VIF of the second image reflected by the light-transmitting member FG is also referred to simply as “virtual position”.

When the magnifying optical system 2 according to the present disclosure is composed of a plurality of optical members, the “optical axis of the magnifying optical system” does not indicate individual optical axes of the respective optical members and indicates the optical axis of light that passes through the magnifying optical system 2 composed of the optical members and enters the second image display panel 20.

In the HUD 100 illustrated in FIG. 1, the first image display panel 10 and the second image display panel 20 are disposed substantially parallel to a plane (X-Y plane) perpendicular to the optical axis of the magnifying optical system 2. Therefore, the virtual image VIR of the first image and the virtual image VIF of the second image visually recognized by the viewer OB are visually recognized by the viewer OB on a virtual plane (VX-VY plane) substantially parallel to the direction indicated by the dashed arrow in FIG. 1.

In the HUD 100 illustrated in FIG. 1, the distance from the point of view of the viewer OB to the first image displayed on the first image display panel 10 is longer than the distance from the point of view of the viewer to the second image displayed on the second image display panel 20. Therefore, the virtual image VIR of the first image displayed on the first image display panel 10 is visually recognized by the viewer OB at a position farther in the direction indicated by the dashed arrow in FIG. 1 than the virtual image VIF of the second image displayed on the second image display panel 20. In other words, the virtual image VIR of the first image displayed on the first image display panel 10 is visually recognized as if it were behind the virtual image VIF of the second image displayed on the second image display panel 20. In the HUD 100 illustrated in FIG. 1, the first image displayed on the first image display panel 10 and the second image displayed on the second image display panel 20 are superimposed on each other in the direction of the line of sight of the viewer OB. Therefore, the virtual image VIR of the first image displayed on the first image display panel 10 is visually recognized by the viewer OB so as to be superimposed on the virtual image VIF of the second image displayed on the second image display panel 20. In such a virtual image optical system, if the first image displayed on the first image display panel 10 and the second image displayed on the second image display panel 20 are images of the same size and the same shape, the virtual image VIR of the first image visually recognized by the viewer OB is larger than the virtual image VIF of the second image.

The following describes the relative positional relation between the virtual images VIR and VIF visually recognized by the viewer OB in the HUD 100.

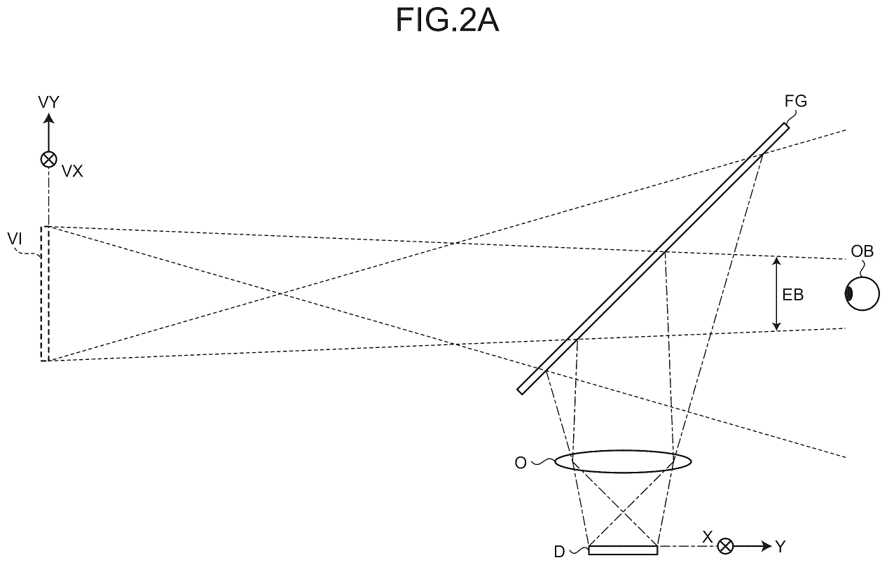

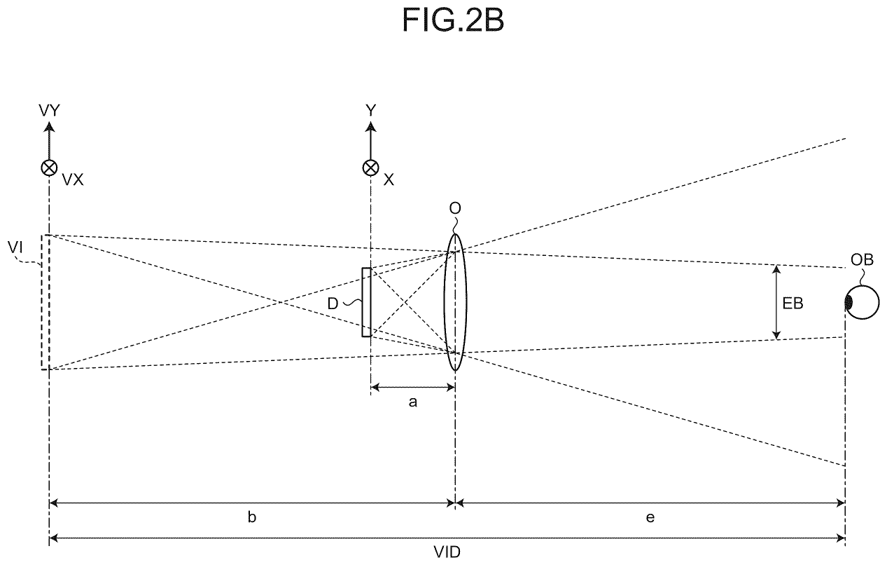

FIG. 2A is a schematic diagram of the basic configuration of the HUD. FIG. 2B is a schematic diagram of an equivalent configuration of the HUD illustrated in FIG. 2A.

An eye box EB illustrated in FIG. 2A indicates the area where the viewer OB can visually recognize a virtual image VI. When a lens O and an image display panel D of the HUD illustrated in FIG. 2A are aligned in the direction of the line of sight of the viewer OB as illustrated in FIG. 2B, the distance “a” (mm) between the image display panel D and the center line of the lens O, the virtual distance “b” (mm) between the virtual image VI and the center line of the lens O, and the focal length “f” (mm) of the lens O have the relation expressed by the following Expression (1). The distance “a” from the image display panel D to the center line of the lens O is smaller than the focal length “f” of the lens O (f>a).

$$\frac{1}{a} - \frac{1}{b} = \frac{1}{f} \qquad ( 1 )$$

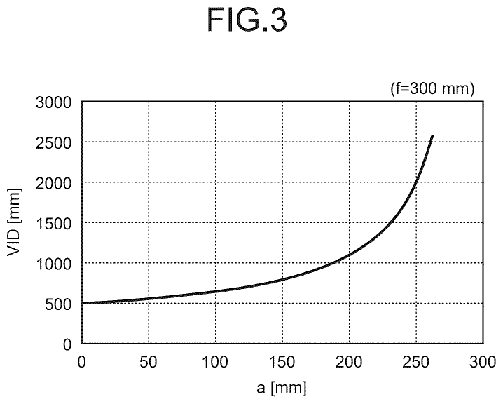

A virtual distance VID (mm) from the point of view of the viewer OB to the virtual image VI is expressed by the following Expression (2) using a distance “e” from the center line of the lens O to the point of view of the viewer OB. FIG. 3 is a graph of the relation between the distance “a” between the panel and the lens and the virtual distance VID between the point of view and the virtual image.

$$VID = b + e = \frac{fa}{f - a} + e \qquad ( 2 )$$

As indicated by Expression (2) and FIG. 3, the virtual distance VID from the point of view of the viewer OB to the virtual image VI increases as the distance “a” from the image display panel D to the center line of the lens O increases. The amount of change in the virtual distance VID from the point of view of the viewer OB to the virtual image VI according to the change in the distance “a” becomes larger as the distance “a” from the image display panel D to the center line of the lens O becomes closer to the focal length “f”.

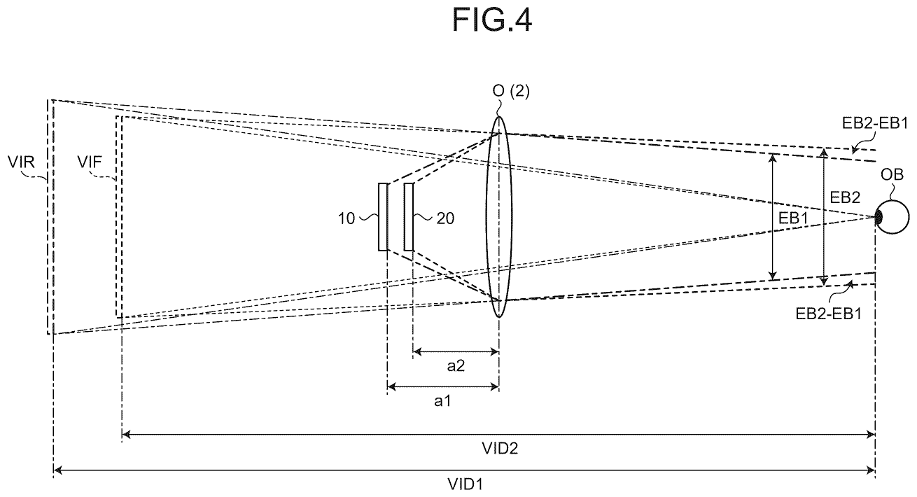

FIG. 4 is a schematic diagram of an equivalent configuration of the HUD. As described above, in the schematic configuration of the HUD 100 illustrated in FIG. 1, the first image display panel 10 is disposed farther away from the magnifying optical system 2 than the second image display panel 20 in the optical axis direction of the magnifying optical system 2, that is, in the direction (Z-direction) orthogonal to the X-Y plane perpendicular to the optical axis of the magnifying optical system 2. Specifically, in the equivalent configuration of the HUD 100 illustrated in FIG. 4, a distance “a1” from the first image display panel 10 to the center line of the lens O (magnifying optical system 2) is larger than a distance “a2” from the second image display panel 20 to the center line of the lens O (magnifying optical system 2) (a1>a2).

A virtual distance VID1 from the point of view of the viewer OB to the virtual image VIR of the first image displayed on the first image display panel 10 corresponds to the distance “a1” from the first image display panel 10 to the center line of the lens O (magnifying optical system 2). A virtual distance VID2 from the point of view of the viewer OB to the virtual image VIF of the second image displayed on the second image display panel 20 corresponds to the distance “a2” from the second image display panel 20 to the center line of the lens O (magnifying optical system 2). Therefore, in the equivalent configuration of the HUD 100 illustrated in FIG. 4, the virtual distance VID1 from the point of view of the viewer OB to the virtual image VIR of the first image displayed on the first image display panel 10 is larger than the virtual distance VID2 from the point of view of the viewer OB to the virtual image VIF of the second image displayed on the second image display panel 20 (VID1>VID2).

Therefore, the virtual image VIR of the first image displayed on the first image display panel 10 is visually recognized at a virtual position farther from the viewer OB than the virtual image VIF of the second image displayed on the second image display panel 20.

As described above, the image output region of the first image display panel 10 and the image output region of the second image display panel 20 according to the present disclosure overlap when viewed in the optical axis direction of the magnifying optical system 2. In other words, the image output region of the first image display panel 10 and the image output region of the second image display panel 20 overlap when viewed in the direction of the line of sight of the observer OB. Therefore, the virtual image VIR of the first image and the virtual image VIF of the second image reflected by the light-transmitting member FG are visually recognized by the viewer OB in such a manner that the virtual images VIR and VIF are superimposed on each other in the direction indicated by the dashed arrow in FIG. 1. In such a configuration, the display device 1 according to the present disclosure can arrange a first object in the virtual image VIR of the first image and a second object in the virtual image VIF of the second image at desired positions in the region where the virtual image VIR of the first image and the virtual image VIF of the second image are superimposed on each other in the direction indicated by the dashed arrow in FIG. 1. The following describes a detailed configuration of the display device 1 that enables the display form described above.

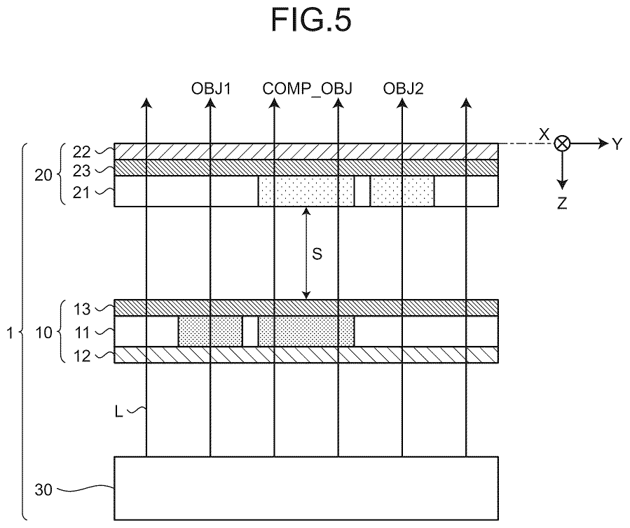

FIG. 5 is a schematic diagram of a detailed configuration of the display device according to the embodiment.

The first image display panel 10 receives direct light from the backlight 30.

The second image display panel 20 is disposed with a gap S interposed between the second image display panel 20 and the first image display panel 10. The second image display panel 20 receives light transmitted through the first image display panel 10.

In the display device 1 according to the embodiment, the first image display panel 10 includes a first liquid crystal panel 11, a first polarizing plate 12, and a first color filter 13. The first color filter 13 is provided between the first polarizing plate 12 and the second image display panel 20. The first liquid crystal panel 11 is provided between the first polarizing plate 12 and the first color filter 13.

In the display device 1 according to the embodiment, the second image display panel 20 includes a second liquid crystal panel 21, a second polarizing plate 22, and a second color filter 23. The second color filter 23 is provided between the second polarizing plate 22 and the first image display panel 10. The second liquid crystal panel 21 is provided between the second color filter 23 and the first color filter 13.

The first liquid crystal panel 11 and the second liquid crystal panel 21 are transmissive liquid crystal display panels and include a plurality of pixels driven by an active matrix system, for example. The pixels are two-dimensionally disposed along the plate surfaces of the first liquid crystal panel 11 and the second liquid crystal panel 21. In the image output region (not illustrated) where the pixels are disposed, the pixels are individually controlled, thereby forming light transmission patterns corresponding to the first image and the second image. Therefore, when incident light is transmitted through the image output region of the first liquid crystal panel 11, the quantity of light is adjusted according to the gradation values of the pixels of the first liquid crystal panel 11 provided at the position corresponding to a first object OBJ1 displayed on the first image display panel 10, and the incident light is output as transmitted light. When incident light is transmitted through the image output region of the second liquid crystal panel 21, the quantity of light is adjusted according to the gradation values of the pixels of the second liquid crystal panel 21 provided at the position corresponding to a second object OBJ2 displayed on the second image display panel 20, and the incident light is output as transmitted light.

The first polarizing plate 12 and the second polarizing plate 22 are disposed with their transmission axes orthogonal to each other with respect to the incident light (crossed Nicols). In the display device 1 according to the present disclosure, no polarizing plate is provided between the first image display panel 10 and the second image display panel 20.

The first polarizing plate 12 is an optical member that transmits light polarized in a first direction and blocks light polarized in a direction different from the first direction. Specifically, the first polarizing plate 12 is, for example, a linear polarizing plate with a transmission axis in the Y-direction.

The second polarizing plate 22 is an optical member that transmits light polarized in a second direction different from the first direction and blocks light polarized in a direction different from the second direction. Specifically, the second polarizing plate 22 is, for example, a linear polarizing plate with a transmission axis in the X-direction.

The first color filter 13 and the second color filter 23 each include a red color resist that transmits red light, a green color resist that transmits green light, and a blue color resist that transmits blue light. The color resists of the respective colors are provided corresponding to the pixels of the first liquid crystal panel 11 and the second liquid crystal panel 21. The color resists of the respective colors are applied to the glass substrates included in the first liquid crystal panel 11 and the second liquid crystal panel 21, for example. In other words, the first color filter 13 and the second color filter 23 each have a first region, a second region, and a third region. The first region transmits first light (e.g., red light) and attenuates light having a wavelength other than at least the first light. The second region transmits second light (e.g., green light) having a wavelength different from the first light (e.g., red light) and attenuates light having a wavelength other than at least the second light. The third region transmits third light (e.g., blue light) having a wavelength different from the first light (e.g., red light) and the second light (e.g., green light) and attenuates light having a wavelength other than at least the third light. In the present disclosure, the region coated with a red color resist corresponds to the first region, the region coated with a green color resist corresponds to the second region, and the region coated with a blue color resist corresponds to the third region.

In the configuration of the display device 1 according to the first embodiment described above, the gradation value of the image viewed from the point of view of the viewer OB is expressed by the following Expression (3) using a gradation value R of the corresponding position in the image output region of the first liquid crystal panel 11 and a gradation value F of the corresponding position in the image output region of the second liquid crystal panel 21. In Expression (3), the gradation value R and the gradation value F are normalized with the maximum value set to 1. The initial orientation and the rotation direction of the liquid crystal molecules of the first liquid crystal panel 11 and the second liquid crystal panel 21 are determined so as to satisfy Expression (3).

$$A = R + F - 2 \times R \times F \qquad ( 3 )$$

For example, when the gradation value R of the position corresponding to the first object OBJ1 displayed on the first image display panel 10 is 0.8 (R=0.8), and the gradation value F is 0 (F=0), a gradation value A of the first object OBJ1 visually recognized by the viewer OB is 0.8 (A=0.8).

For example, when the gradation value R of the position corresponding to the second object OBJ2 displayed on the second image display panel 20 is 0 (R=0), and the gradation value F is 0.4 (F=0.4), the gradation value A of the second object OBJ2 visually recognized by the viewer OB is 0.4 (A=0.4).

In a display form where the first object OBJ1 displayed on the first image display panel 10 and the second object OBJ2 displayed on the second image display panel 20 are superimposed on each other in the direction of the line of sight of the viewer OB to form one composite object COMP_OBJ (which will be described later), when the gradation value R of the position corresponding to the composite object COMP_OBJ is 0.8 (R=0.8), and the gradation value F is 0.4 (F=0.4), the gradation value A of the composite object COMP_OBJ visually recognized by the viewer OB is 0.56 (A=0.56).

When the composite object COMP_OBJ is visually recognized by the viewer OB in the HUD 100 in which the display device 1 according to the embodiment is used, the first object OBJ1 in the virtual image VIR of the first image is smaller than the second object OBJ2 in the virtual image VIF of the second image. If the point of view of the viewer OB deviates, the first object OBJ1 in the virtual image VIR of the first image and the second object OBJ2 in the virtual image VIF of the second image may possibly be visually recognized out of alignment, thereby causing visual discomfort to the viewer OB.

In the configuration according to the present disclosure that allows the virtual image VIR of the first image and the virtual image VIF of the second image to be visually recognized by the viewer, the region where the first object OBJ1 and the second object OBJ2 are visually recognized out of alignment by the viewer OB is limited to a region EB2−EB1 where an eye box EB1 does not overlap an eye box EB2 (refer to FIG. 4). The eye box EB1 is a region in which the virtual image VIR of the first image can be visually recognized, and the eye box EB2 is a region in which the virtual image VIF of the second image can be visually recognized.

The following describes a specific example of the display form of the HUD 100 in which the display device 1 according to the embodiment is used.

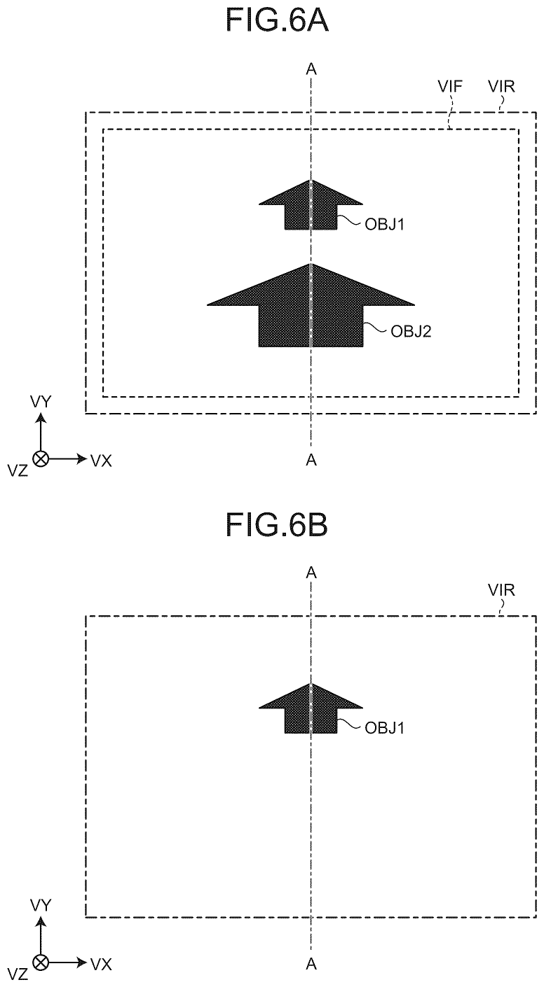

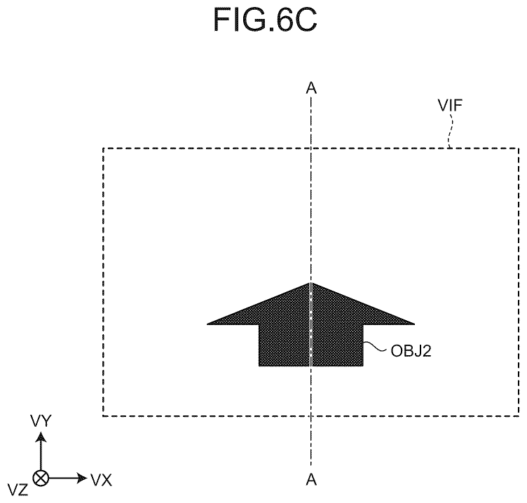

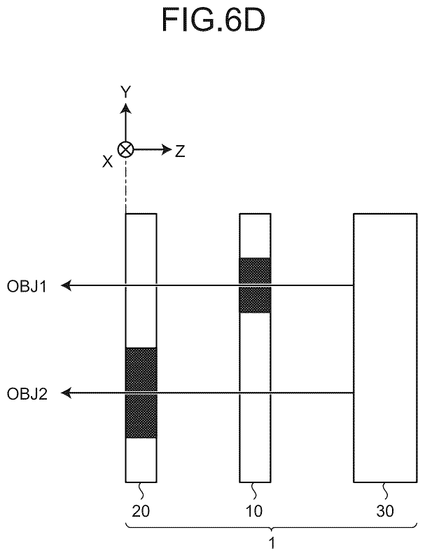

FIG. 6A is a diagram illustrating a first example of the display form of the HUD in which the display device according to the embodiment is used. FIG. 6B is a diagram of the first object visually recognized in the virtual image of the first image in the display form illustrated in FIG. 6A. FIG. 6C is a diagram of the second object visually recognized in the virtual image of the second image in the display form illustrated in FIG. 6A. FIG. 6D is a sectional view of the display device illustrated in FIG. 6A along line A-A.

In the display form illustrated in FIG. 6A, the first object OBJ1 and the second object OBJ2 are visually recognized by the viewer OB such that the first object OBJ1 is positioned at a relatively upper part and that the second object OBJ2 is positioned at a relatively lower part in the region where the first image displayed on the first image display panel 10 and the second image displayed on the second image display panel 20 are superimposed on each other in the direction of the line of sight of the viewer OB, that is, in the region where the virtual image VIR of the first image and the virtual image VIF of the second image overlap when viewed in the direction indicated by the dashed arrow in FIG. 1.

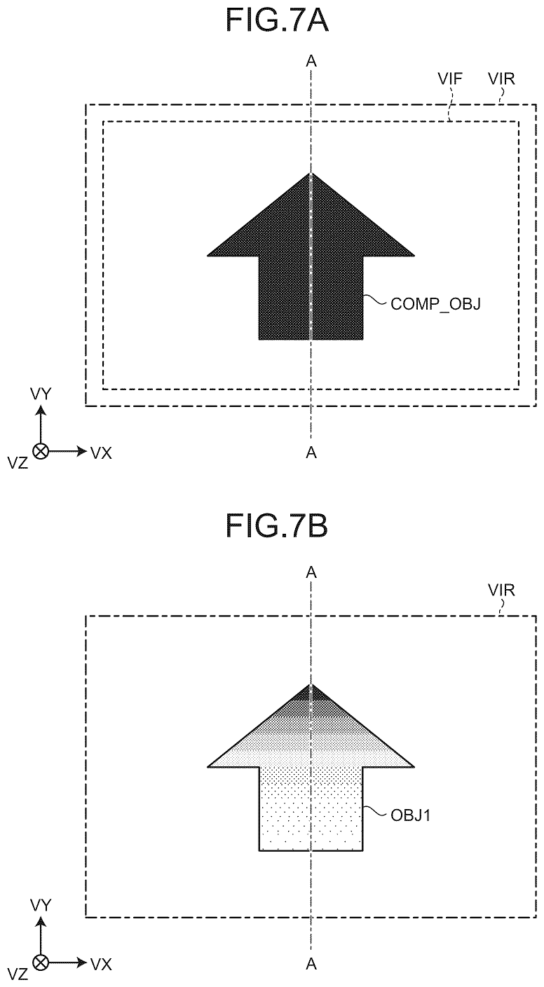

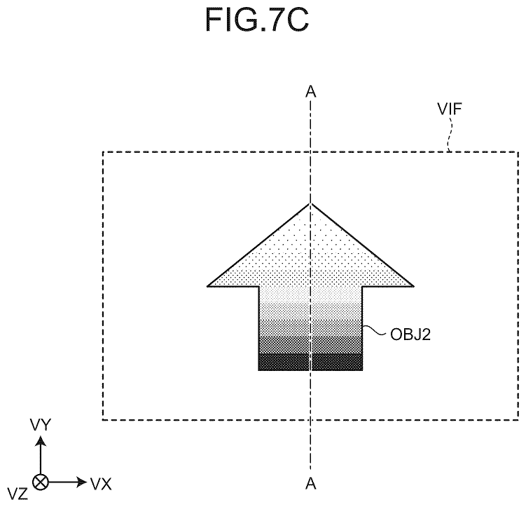

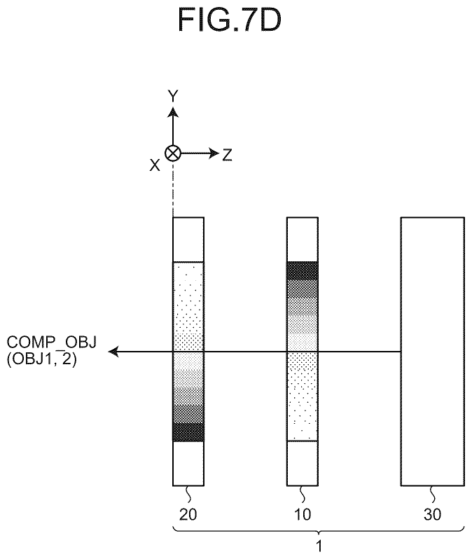

FIG. 7A is a diagram illustrating a second example of the display form of the HUD in which the display device according to the embodiment is used. FIG. 7B is a diagram of the first object visually recognized in the virtual image of the first image in the display form illustrated in FIG. 7A. FIG. 7C is a diagram of the second object visually recognized in the virtual image of the second image in the display form illustrated in FIG. 7A. FIG. 7D is a sectional view of the display device illustrated in FIG. 7A along line A-A.

In the display form illustrated in FIG. 7A, the first object OBJ1 displayed on the first image display panel 10 and the second object OBJ2 displayed on the second image display panel 20 are superimposed on each other in the direction of the line of sight of the viewer OB to form one composite object COMP_OBJ. In other words, one composite object COMP_OBJ composed of the first object OBJ1 and the second object OBJ2 that are superimposed on each other in the direction indicated by the dashed arrow in FIG. 1 is visually recognized by the viewer OB in the region where the virtual image VIR of the first image and the virtual image VIF of the second image are superimposed on each other in the direction indicated by the dashed arrow in FIG. 1. As the gradation value of the first object OBJ1 increases, the gradation value of the second object OBJ2 decreases. Therefore, the composite object COMP_OBJ that gives the illusion of being inclined forward at the bottom and backward at the top, is visually recognized by the viewer OB in the region where the virtual image VIR of the first image and the virtual image VIF of the second image are superimposed on each other in the direction indicated by the dashed arrow in FIG. 1 from the point of view of the viewer OB.

Thus, the HUD 100 in which the display device 1 according to the embodiment is used can freely arrange the first object OBJ1 in the virtual image VIR of the first image and the second object OBJ2 in the virtual image VIF of the second image in the region where the virtual image VIR of the first image and the virtual image VIF of the second image are visually recognized by the viewer OB in a state where those images are superimposed on each other in the direction indicated by the dashed arrow in FIG. 1.

In the display form where the first object OBJ1 displayed on the first image display panel 10 and the second object OBJ2 displayed on the second image display panel 20 are superimposed on each other in the direction of the line of sight of the viewer OB to form one composite object COMP_OBJ, the gradation value of the second object OBJ2 is controlled to decrease as the gradation value of the first object OBJ1 increases in at least one direction in the region where the virtual image VIR of the first image and the virtual image VIF of the second image are superimposed on each other in the direction indicated by the dashed arrow in FIG. 1. Therefore, the composite object COMP_OBJ can be visually recognized by the viewer OB as if it were inclined in one direction.

In the display device 1 according to the embodiment, the first image display panel 10 is irradiated with the output light L from the backlight 30. The transmitted light of the first image displayed on the first image display panel 10 is further transmitted through the second image display panel 20. The quantity of light of the first object OBJ1 on the first image displayed on the first image display panel 10 is reduced by being transmitted through the second color filter 23 provided to the second image display panel 20.

In the display device 1 according to the embodiment, the second image display panel 20 is irradiated with the light transmitted through the first image display panel 10. The quantity of transmitted light of the first image display panel 10 output to the second image display panel 20 is reduced by being transmitted through the first color filter 13 provided to the first image display panel 10.

In what is called a liquid crystal display device with a color filter, the color gamut can be expanded by making the colors of the color filter darker. If the colors of the color filter are made darker, however, the light transmittance decreases, and the quantity of transmitted light decreases, resulting in reduced luminance of the display screen. In other words, decrease in the quantity of transmitted light can be reduced by making the colors of the color filter lighter and making the color gamut smaller.

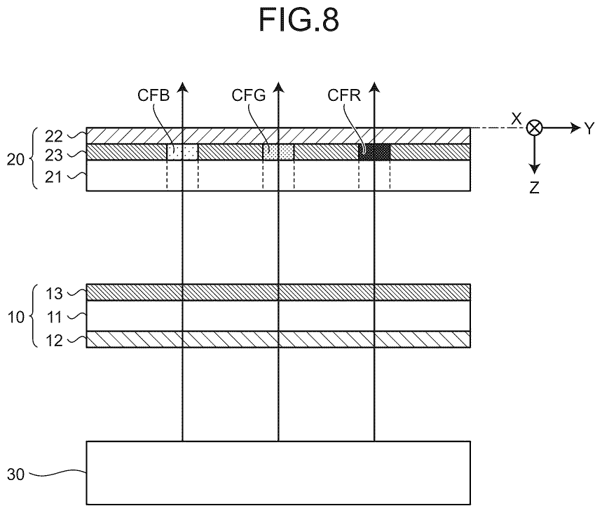

The following describes the color gamut of the display device according to a comparative example with reference to FIGS. 8 to 15.

FIG. 8 is a diagram conceptually illustrating a state where the second image is displayed on the second image display panel in the display device according to the comparative example. FIG. 8 illustrates the arrows indicating light rays passing through a red color resist CFR (first region) corresponding to the sub-pixel that reproduces red in the second image, a green color resist CFG (second region) corresponding to the sub-pixel that reproduces green in the second image, and a blue color resist CFB (third region) corresponding to the sub-pixel that reproduces blue in the second image. In the comparative example, the characteristics (color intensity) of the first color filter 13 and the second color filter 23 are substantially the same. Specifically, in the example illustrated in FIG. 8, the thicknesses of the first color filter 13 and the second color filter 23 in the Z-direction are substantially equal.

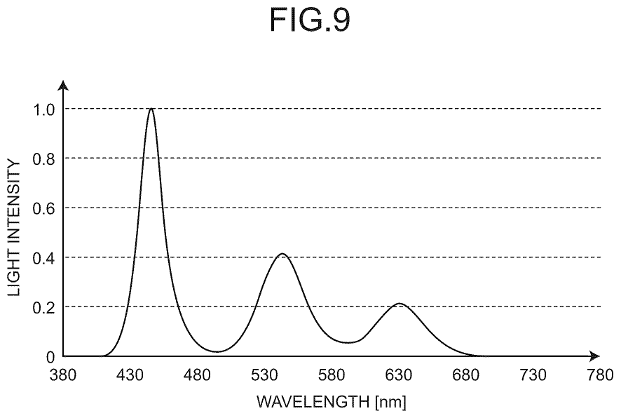

FIG. 9 is a graph of an example of the emission spectrum of the backlight. The horizontal axis in FIG. 9 indicates the wavelength, and the vertical axis indicates the emission intensity (relative value) of the backlight. FIG. 9 illustrates an example with peaks near 630 nm corresponding to red light, near 550 nm corresponding to green light, and near 440 nm corresponding to blue light.

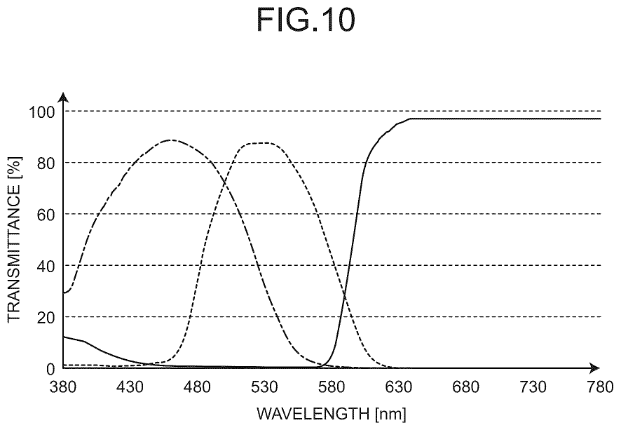

FIG. 10 is a graph of an example of the spectral transmittance of the first color filter and the second color filter in the display device according to the comparative example. The horizontal axis in FIG. 10 indicates the wavelength, and the vertical axis indicates the transmittance of each color resist. In FIG. 10, the solid line indicates the transmittance of the red color resist, the dashed line indicates the transmittance of the green color resist, and the alternate long and short dash line indicates the transmittance of the blue color resist. The red color resist (first region) has a characteristic of transmitting light in a predetermined wavelength band near 630 nm, which corresponds to red light, and attenuating light outside the wavelength band. The green color resist (second region) has a characteristic of transmitting light in a predetermined wavelength band near 550 nm, which corresponds to green light, and attenuating light outside the wavelength band. The blue color resist (third region) has a characteristic of transmitting light in a predetermined wavelength band near 440 nm, which corresponds to blue light, and attenuating light outside the wavelength band.

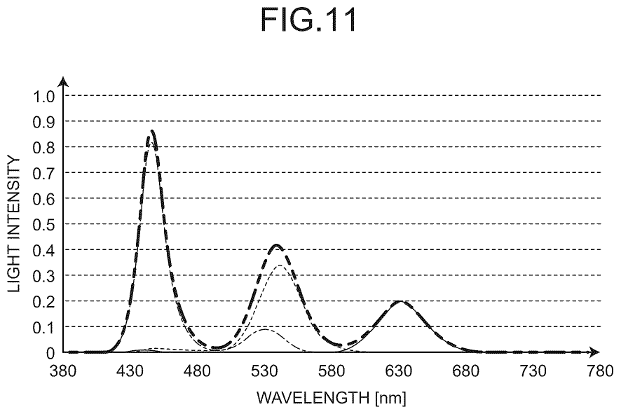

FIG. 11 is a graph of an example of the transmitted light spectrum of the first color filter and the incident light spectrum of the second color filter in the display device according to the comparative example. The horizontal axis in FIG. 11 indicates the wavelength, and the vertical axis indicates the light intensity (relative value) of the transmitted light of the first color filter when the gradation of each color of the first image is 0. In FIG. 11, the solid line indicates the spectrum of light transmitted through the red color resist, the dashed line indicates the spectrum of light transmitted through the green color resist, and the alternate long and short dash line indicates the spectrum of light transmitted through the blue color resist. The alternate long and two short dashes line in FIG. 11 indicates the spectrum of light incident on the second image displayed on the second image display panel 20 as a result of being transmitted through the first color filter.

Light transmitted through the color resists of the first color filter 13 of the first image display panel 10 is incident on the color resists of the second color filter 23 of the second image display panel 20.

More specifically, composite light transmitted through the color resists of the first color filter 13 of the first image display panel 10 is incident on the red color resist of the second color filter 23 of the second image display panel 20. Composite light transmitted through the color resists of the first color filter 13 of the first image display panel 10 is incident on the green color resist of the second color filter 23 of the second image display panel 20. Composite light transmitted through the color resists of the first color filter 13 of the first image display panel 10 is incident on the blue color resist of the second color filter 23 of the second image display panel 20.

As a result, the incident light spectrum of the second image displayed on the second image display panel 20 is represented as a composite light spectrum obtained by combining light rays transmitted through the respective color resists of the first color filter 13 of the first image display panel 10 as indicated by the alternate long and two short dashes line in FIG. 11.

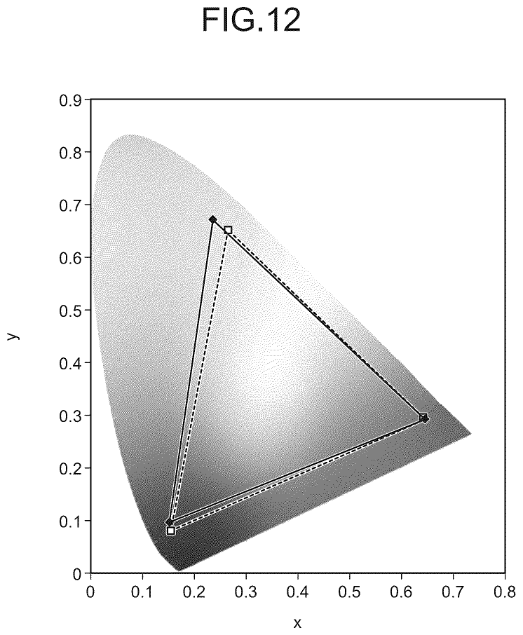

The color gamut of the second image displayed on the second image display panel 20 depends on the transmitted light transmitted through the color resists of the second color filter 23. FIG. 12 is a schematic diagram (chromaticity diagram) of an example of the color gamut of the second image when the second image is displayed on the second image display panel in the display device according to the comparative example. The solid line in FIG. 12 indicates the color gamut of the second image transmitted through the second image display panel 20. The dashed line in FIG. 12 indicates the color gamut of the transmitted light of the first image display panel 10.

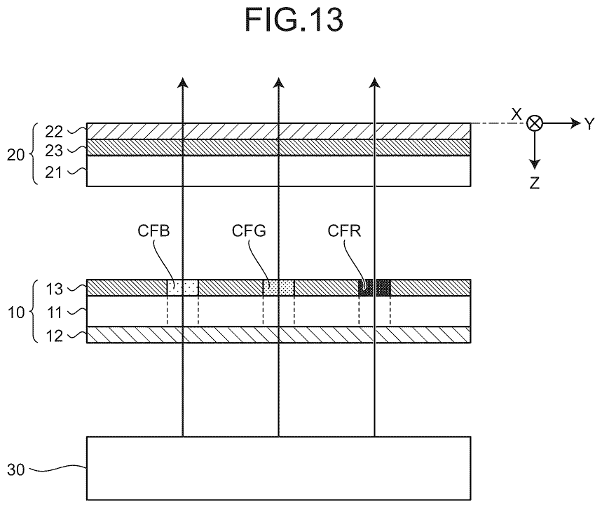

FIG. 13 is a diagram conceptually illustrating a state where the first image is displayed on the first image display panel in the display device according to the comparative example. FIG. 13 illustrates the arrows indicating light rays passing through the red color resist CFR (first region) corresponding to the sub-pixel that reproduces red in the first image, the green color resist CFG (second region) corresponding to the sub-pixel that reproduces green in the first image, and the blue color resist CFB (third region) corresponding to the sub-pixel that reproduces blue in the first image.

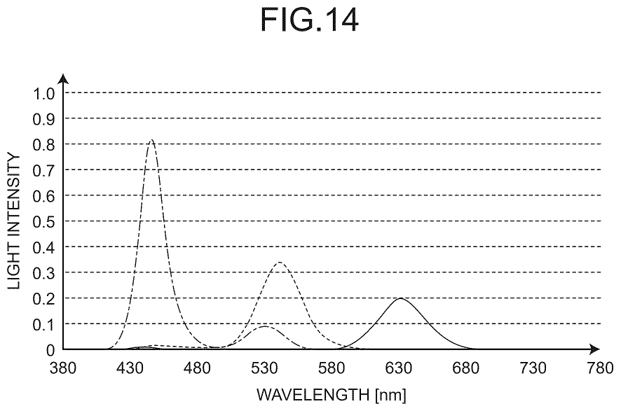

FIG. 14 is a graph of an example of the transmitted light spectrum of the first color filter and the incident light spectrum of the second color filter in the display device according to the comparative example. The horizontal axis in FIG. 14 indicates the wavelength, and the vertical axis indicates the light intensity (relative value) of the transmitted light of the first color filter when the gradation of each color of the first image is 0. In FIG. 14, the solid line indicates the spectrum of light transmitted through the red color resist, the dashed line indicates the spectrum of light transmitted through the green color resist, and the alternate long and short dash line indicates the spectrum of light transmitted through the blue color resist. The peak value of each spectrum illustrated in FIG. 14 corresponds to the gradation values of the sub-pixels that reproduce the corresponding colors in the second image.

The first image displayed on the first image display panel 10 receives the output light from the backlight 30, illustrated in FIG. 9.

Light transmitted through the color resists of the first color filter 13 of the first image display panel 10 is incident on the color resists of the second color filter 23 of the second image display panel 20.

More specifically, light transmitted through the red color resist of the first color filter 13 of the first image display panel 10 is incident on each color resist of the second color filter 23 of the second image display panel 20. Light transmitted through the green color resist of the first color filter 13 of the first image display panel 10 is incident on each color resist of the second color filter 23 of the second image display panel 20. Light transmitted through the blue color resist of the first color filter 13 of the first image display panel 10 is incident on each color resist of the second color filter 23 of the second image display panel 20.

Specifically, for example, when red is displayed on the first image display panel 10, light transmitted through the red color resist of the first image display panel 10 is incident on the second image display panel 20. The red light incident on the second image display panel 20 is transmitted through each color resist of the second image display panel 20, and color composited by the light transmitted through the color resists of the second image display panel 20 is visually recognized by the viewer.

For example, when green is displayed on the first image display panel 10, light transmitted through the green color resist of the first image display panel 10 is incident on the second image display panel 20. The green light incident on the second image display panel 20 is transmitted through each color resist of the second image display panel 20, and color composited by the light transmitted through the color resists of the second image display panel 20 is visually recognized by the viewer.

For example, when blue is displayed on the first image display panel 10, light transmitted through the blue color resist of the first image display panel 10 is incident on the second image display panel 20. The blue light incident on the second image display panel 20 is transmitted through each color resist of the second image display panel 20, and color composited by the light transmitted through the color resists of the second image display panel 20 is visually recognized by the viewer.

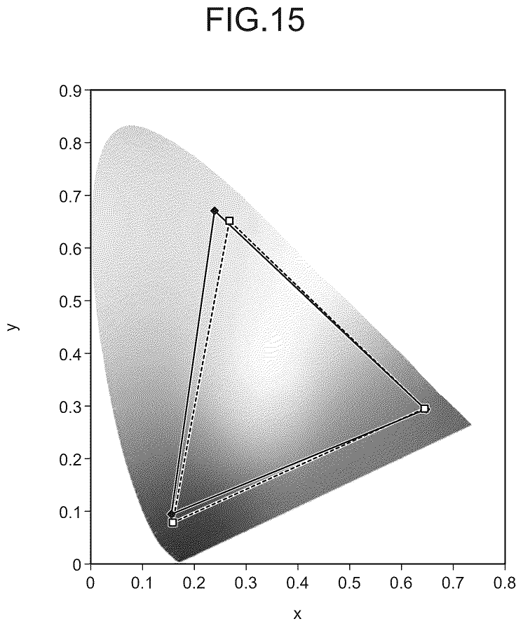

The color gamut of the first image displayed on the first image display panel 10 depends on the transmitted light transmitted through the color resists of the second color filter 23. FIG. 15 is a schematic diagram (chromaticity diagram) of an example of the color gamut of the first image when the first image is displayed on the first image display panel in the display device according to the comparative example. The solid line in FIG. 15 indicates the color gamut of the first image transmitted through the second image display panel 20. The dashed line in FIG. 15 indicates the color gamut of the first image transmitted through the first image display panel 10.

In the display device according to the comparative example, the thicknesses of the first color filter 13 and the second color filter 23 in the Z-direction are substantially equal as described above. Therefore, as illustrated in FIGS. 12 and 15, the color gamut of the first image by the first color filter 13 and the color gamut of the second image by the second color filter 23 are substantially the same. The configuration according to the present disclosure enables the viewer OB to visually recognize both the display images on the first image display panel 10 and the second image display panel 20 disposed overlapping when viewed in the direction of the line of sight of the viewer OB by providing no polarizing plate between the first image display panel 10 and the second image display panel 20 and disposing the first polarizing plate 12 and the second polarizing plate 22 in a crossed Nicols arrangement. To further improve the visibility of the display images, it is desirable to reduce the decrease in the quantity of transmitted light.

The following describes a specific configuration that can reduce the decrease in the quantity of transmitted light in the configuration that enables the viewer OB to visually recognize both the display images on the first image display panel 10 and the second image display panel 20 disposed overlapping when viewed in the direction of the line of sight of the viewer OB.

### First Embodiment

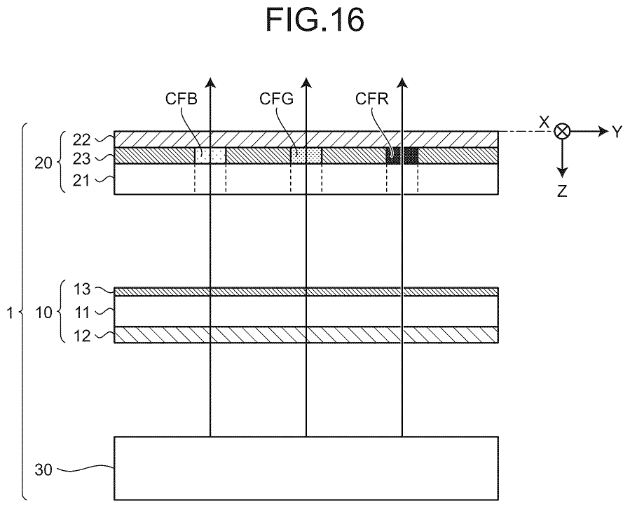

FIG. 16 is a diagram conceptually illustrating a state where the second image is displayed on the second image display panel in the display device according to a first embodiment. FIG. 16 illustrates the arrows indicating light rays passing through a red color resist CFR (first region) corresponding to the sub-pixel that reproduces red in the second image, a green color resist CFG (second region) corresponding to the sub-pixel that reproduces green in the second image, and a blue color resist CFB (third region) corresponding to the sub-pixel that reproduces blue in the second image.

In the display device 1 according to the first embodiment, the color intensities of the first color filter 13 and the second color filter 23 are different from each other. Specifically, in the configuration according to the first embodiment, the thickness of the first color filter 13 in the Z-direction is less than that of the second color filter 23 in the Z-direction as illustrated in FIG. 16. The thickness of the second color filter 23 in the Z-direction is substantially equal to those of the first color filter 13 and the second color filter 23 in the comparative example described above. With this configuration, the color gamut of the second image displayed on the second image display panel 20 is smaller than in the comparative example.

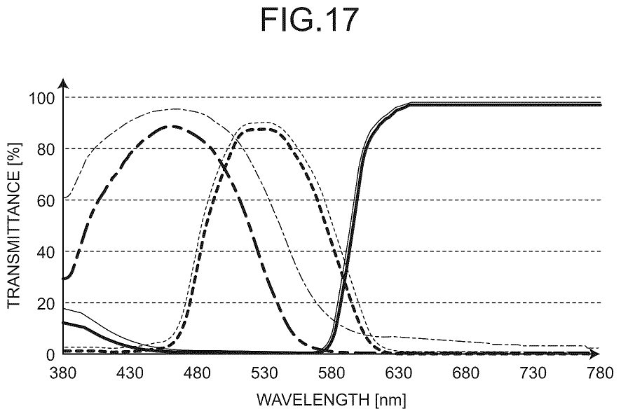

FIG. 17 is a graph of an example of the spectral transmittance of the first color filter and the second color filter in the display device according to the first embodiment. The horizontal axis in FIG. 17 indicates the wavelength, and the vertical axis indicates the transmittance of each color resist. In FIG. 17, the thick solid line indicates the transmittance of the red color resist of the second color filter 23, the thick dashed line indicates the transmittance of the green color resist of the second color filter 23, and the thick alternate long and short dash line indicates the transmittance of the blue color resist of the second color filter 23. The thin solid line indicates the transmittance of the red color resist of the first color filter 13, the thin dashed line indicates the transmittance of the green color resist of the first color filter 13, and the thin alternate long and short dash line indicates the transmittance of the blue color resist of the first color filter 13. The full width at half maximum of the transmittance of the green color resist of the second color filter 23 indicated by the thick dashed line is narrower than that of the transmittance of the green color resist of the first color filter 13 indicated by the thin dashed line. The full width at half maximum of the transmittance of the blue color resist of the second color filter 23 indicated by the thick alternate long and short dash line is narrower than that of the transmittance of the blue color resist of the first color filter 13 indicated by the thin alternate long and short dash line.

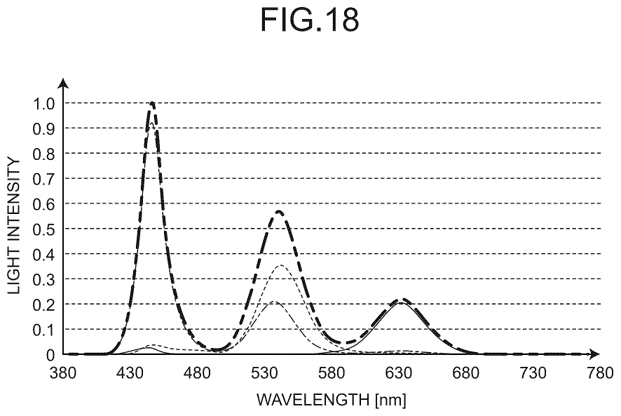

FIG. 18 is a graph of an example of the transmitted light spectrum of the first color filter and the incident light spectrum of the second color filter in the display device according to the first embodiment. The horizontal axis in FIG. 18 indicates the wavelength, and the vertical axis indicates the light intensity (relative value) of the transmitted light of the first color filter when the gradation of each color of the first image is 0. In FIG. 18, the solid line indicates the spectrum of light transmitted through the red color resist, the dashed line indicates the spectrum of light transmitted through the green color resist, and the alternate long and short dash line indicates the spectrum of light transmitted through the blue color resist. The alternate long and two short dashes line in FIG. 18 indicates the spectrum of light incident on the second image displayed on the second image display panel 20 as a result of being transmitted through the first color filter.

Light transmitted through the color resists of the first color filter 13 of the first image display panel 10 is incident on the color resists of the second color filter 23 of the second image display panel 20.

More specifically, composite light transmitted through the color resists of the first color filter 13 of the first image display panel 10 is incident on the red color resist of the second color filter 23 of the second image display panel 20. Composite light transmitted through the color resists of the first color filter 13 of the first image display panel 10 is incident on the green color resist of the second color filter 23 of the second image display panel 20. Composite light transmitted through the color resists of the first color filter 13 of the first image display panel 10 is incident on the blue color resist of the second color filter 23 of the second image display panel 20.

As a result, the incident light spectrum of the second image displayed on the second image display panel 20 is represented as a composite light spectrum obtained by combining light rays transmitted through the respective color resists of the first color filter 13 of the first image display panel 10 as indicated by the alternate long and two short dashes line in FIG. 18.

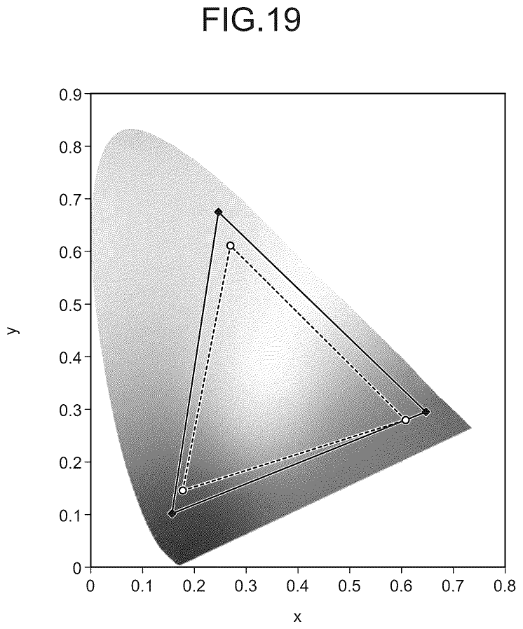

The color gamut of the second image displayed on the second image display panel 20 depends on the transmitted light transmitted through the color resists of the second color filter 23. FIG. 19 is a schematic diagram (chromaticity diagram) of an example of the color gamut of the second image when the second image is displayed on the second image display panel in the display device according to the first embodiment. The solid line in FIG. 19 indicates the color gamut of the second image transmitted through the second image display panel 20. The dashed line in FIG. 19 indicates the color gamut of the transmitted light of the first image display panel 10.

In the display device 1 according to the first embodiment, when the second image is displayed on the second image display panel 20, the color gamut of the transmitted light of the first image display panel 10 is smaller than that of the display device according to the comparative example. However, the color gamut of the second image displayed on the second image display panel 20 with the transmitted light of the first image display panel 10 is larger than that of the transmitted light of the first image display panel 10 as illustrated in FIG. 19. In the configuration of the display device 1 according to the first embodiment, the thickness of the first color filter 13 in the Z-direction is less than that of the second color filter 23 in the Z-direction. Therefore, the luminance of the second image displayed on the second image display panel 20 can be increased. Specifically, the luminance of the second image displayed on the second image display panel 20 can be, for example, approximately 1.3 times the luminance of the configuration according to the comparative example.

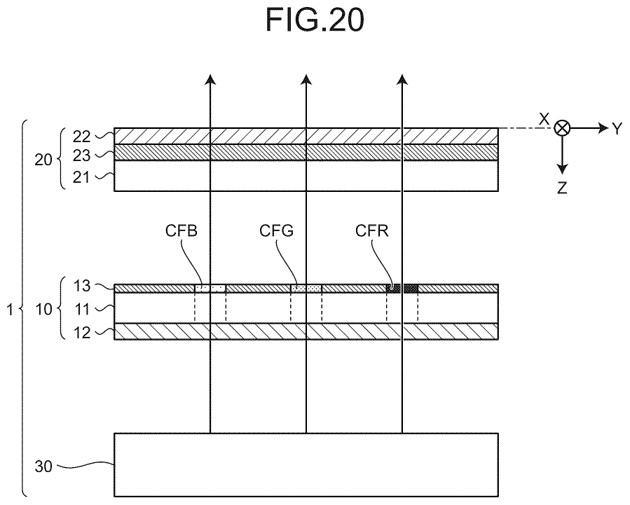

FIG. 20 is a diagram conceptually illustrating a state where the first image is displayed on the first image display panel in the display device according to the first embodiment. FIG. 20 illustrates the arrows indicating light rays passing through the red color resist CFR (first region) corresponding to the sub-pixel that reproduces red in the first image, the green color resist CFG (second region) corresponding to the sub-pixel that reproduces green in the first image, and the blue color resist CFB (third region) corresponding to the sub-pixel that reproduces blue in the first image.

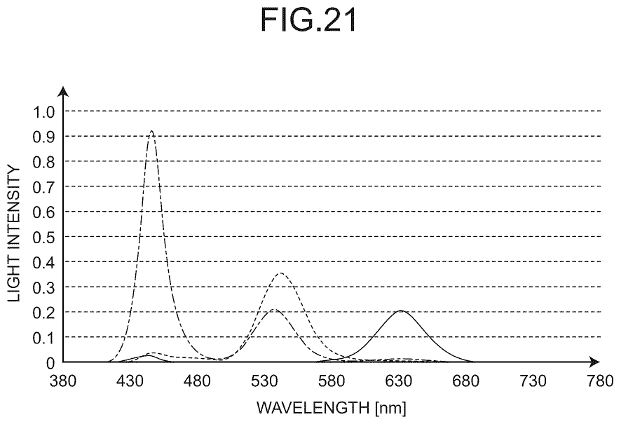

FIG. 21 is a graph of an example of the transmitted light spectrum of the first color filter in the display device according to the first embodiment. The horizontal axis in FIG. 21 indicates the wavelength, and the vertical axis indicates the light intensity (relative value) of the transmitted light of the first color filter when the gradation of each color of the first image is 0. In FIG. 21, the solid line indicates the spectrum of light transmitted through the red color resist, the dashed line indicates the spectrum of light transmitted through the green color resist, and the alternate long and short dash line indicates the spectrum of light transmitted through the blue color resist. The peak value of each spectrum illustrated in FIG. 21 corresponds to the gradation values of the sub-pixels that reproduce the corresponding colors in the second image.

The first image displayed on the first image display panel 10 receives the output light from the backlight 30, illustrated in FIG. 9.

Light transmitted through the color resists of the first color filter 13 of the first image display panel 10 is incident on the color resists of the second color filter 23 of the second image display panel 20.

More specifically, light transmitted through the red color resist of the first color filter 13 of the first image display panel 10 is incident on each color resist of the second color filter 23 of the second image display panel 20. Light transmitted through the green color resist of the first color filter 13 of the first image display panel 10 is incident on each color resist of the second color filter 23 of the second image display panel 20. Light transmitted through the blue color resist of the first color filter 13 of the first image display panel 10 is incident on each color resist of the second color filter 23 of the second image display panel 20.

Specifically, for example, when red is displayed on the first image display panel 10, light transmitted through the red color resist of the first image display panel 10 is incident on the second image display panel 20. The red light incident on the second image display panel 20 is transmitted through each color resist of the second image display panel 20, and color composited by the light transmitted through the color resists of the second image display panel 20 is visually recognized by the viewer.

For example, when green is displayed on the first image display panel 10, light transmitted through the green color resist of the first image display panel 10 is incident on the second image display panel 20. The green light incident on the second image display panel 20 is transmitted through each color resist of the second image display panel 20, and color composited by the light transmitted through the color resists of the second image display panel 20 is visually recognized by the viewer.

For example, when blue is displayed on the first image display panel 10, light transmitted through the blue color resist of the first image display panel 10 is incident on the second image display panel 20. The blue light incident on the second image display panel 20 is transmitted through each color resist of the second image display panel 20, and color composited by the light transmitted through the color resists of the second image display panel 20 is visually recognized by the viewer.

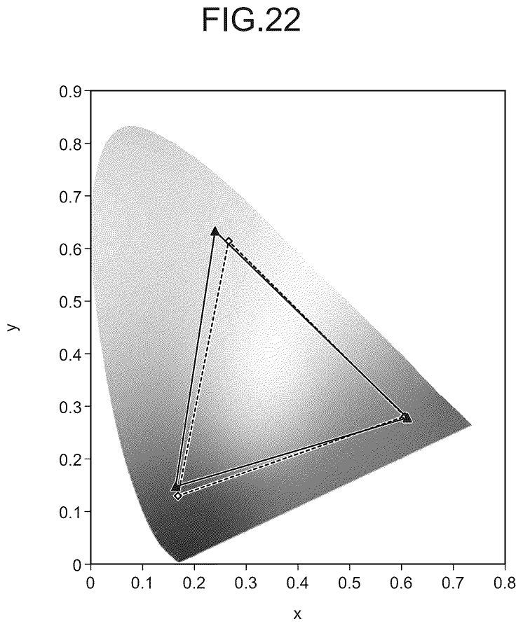

The color gamut of the first image displayed on the first image display panel 10 depends on the transmitted light transmitted through the color resists of the second color filter 23. FIG. 22 is a schematic diagram (chromaticity diagram) of an example of the color gamut of the first image when the first image is displayed on the first image display panel in the display device according to the first embodiment. The solid line in FIG. 22 indicates the color gamut of the first image transmitted through the second image display panel 20. The dashed line in FIG. 22 indicates the color gamut of the first image transmitted through the first image display panel 10.

In the display device 1 according to the first embodiment, when the first image is displayed on the first image display panel, the color gamut of the first image transmitted through the second image display panel 20 is not significantly different from that of the first image transmitted through the first image display panel 10 and is smaller than in the configuration of the display device according to the comparative example as illustrated in FIG. 22. Therefore, the color gamut of the first image indicated by the solid line in FIG. 22 is smaller than that of the second image indicated by the solid line in FIG. 19. Also in this case, the luminance of the first image displayed on the first image display panel 10 can be increased by making the thickness of the first color filter 13 in the Z-direction less than that of the second color filter 23 in the Z-direction. Specifically, the luminance of the first image displayed on the first image display panel 10 can be, for example, approximately 1.3 times the luminance of the configuration according to the comparative example.

As described above, in the display device 1 according to the first embodiment, the thickness of the first color filter 13 in the Z-direction is less than that of the second color filter 23 in the Z-direction. This configuration can increase the quantity of light transmitted through the first color filter 13, thereby reducing the decrease in the quantity of transmitted light of the display device 1.

### Second Embodiment

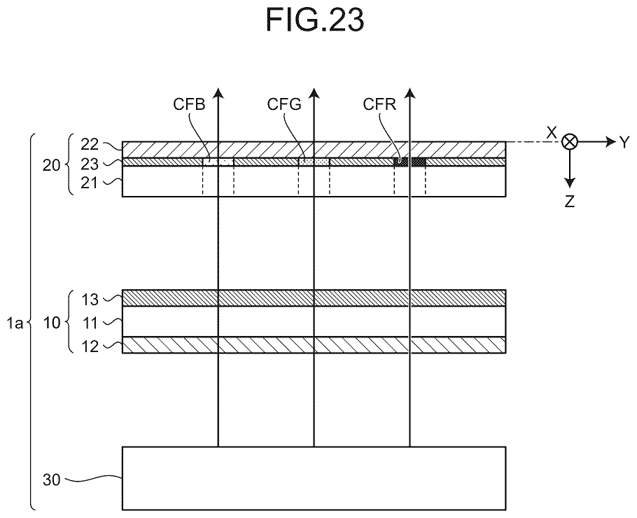

FIG. 23 is a diagram conceptually illustrating a state where the second image is displayed on the second image display panel in the display device according to a second embodiment. FIG. 23 illustrates the arrows indicating light rays passing through a red color resist CFR (first region) corresponding to the sub-pixel that reproduces red in the second image, a green color resist CFG (second region) corresponding to the sub-pixel that reproduces green in the second image, and a blue color resist CFB (third region) corresponding to the sub-pixel that reproduces blue in the second image.

In a display device 1a according to the second embodiment, the color intensities of the first color filter 13 and the second color filter 23 are different from each other similarly to the first embodiment. Specifically, in the configuration according to the second embodiment, the thickness of the second color filter 23 in the Z-direction is less than that of the first color filter 13 in the Z-direction as illustrated in FIG. 23. The thickness of the first color filter 13 in the Z-direction is equal to those of the first color filter 13 and the second color filter 23 in the comparative example described above. With this configuration, the color gamut of the first image displayed on the first image display panel 10 is smaller than in the comparative example.

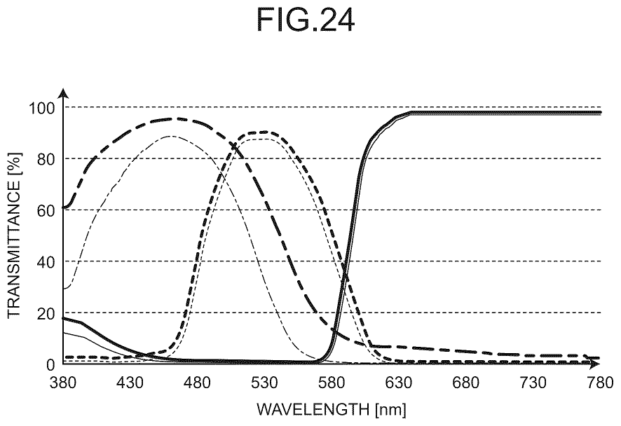

FIG. 24 is a graph of an example of the spectral transmittance of the first color filter and the second color filter in the display device according to the second embodiment. The horizontal axis in FIG. 24 indicates the wavelength, and the vertical axis indicates the transmittance of each color resist. In FIG. 24, the thick solid line indicates the transmittance of the red color resist of the first color filter 13, the thick dashed line indicates the transmittance of the green color resist of the first color filter 13, and the thick alternate long and short dash line indicates the transmittance of the blue color resist of the first color filter 13. The thin solid line indicates the transmittance of the red color resist of the second color filter 23, the thin dashed line indicates the transmittance of the green color resist of the second color filter 23, and the thin alternate long and short dash line indicates the transmittance of the blue color resist of the second color filter 23.

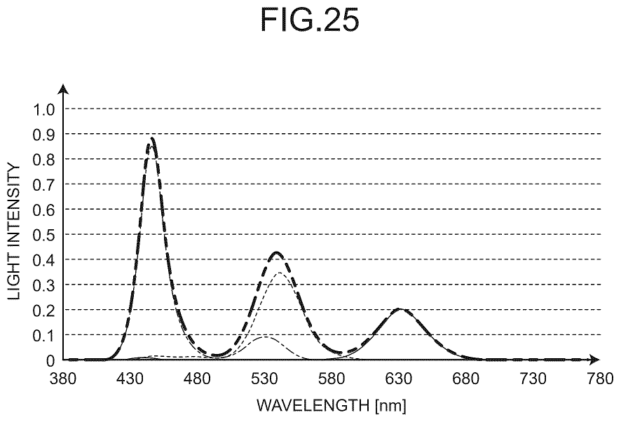

FIG. 25 is a graph of an example of the transmitted light spectrum of the first color filter and the incident light spectrum of the second color filter in the display device according to the second embodiment. The horizontal axis in FIG. 25 indicates the wavelength, and the vertical axis indicates the light intensity (relative value) of the transmitted light of the first color filter. In FIG. 25, the solid line indicates the spectrum of light transmitted through the red color resist, the dashed line indicates the spectrum of light transmitted through the green color resist, and the alternate long and short dash line indicates the spectrum of light transmitted through the blue color resist. The alternate long and two short dashes line in FIG. 25 indicates the spectrum of light incident on the second image displayed on the second image display panel 20 as a result of being transmitted through the first color filter.

Light transmitted through the color resists of the first color filter 13 of the first image display panel 10 is incident on the color resists of the second color filter 23 of the second image display panel 20.

More specifically, composite light transmitted through the color resists of the first color filter 13 of the first image display panel 10 is incident on the red color resist of the second color filter 23 of the second image display panel 20. Composite light transmitted through the color resists of the first color filter 13 of the first image display panel 10 is incident on the green color resist of the second color filter 23 of the second image display panel 20. Composite light transmitted through the color resists of the first color filter 13 of the first image display panel 10 is incident on the blue color resist of the second color filter 23 of the second image display panel 20.

As a result, the incident light spectrum of the second image displayed on the second image display panel 20 is represented as a composite light spectrum obtained by combining light rays transmitted through the respective color resists of the first color filter 13 of the first image display panel 10 as indicated by the alternate long and two short dashes line in FIG. 25.

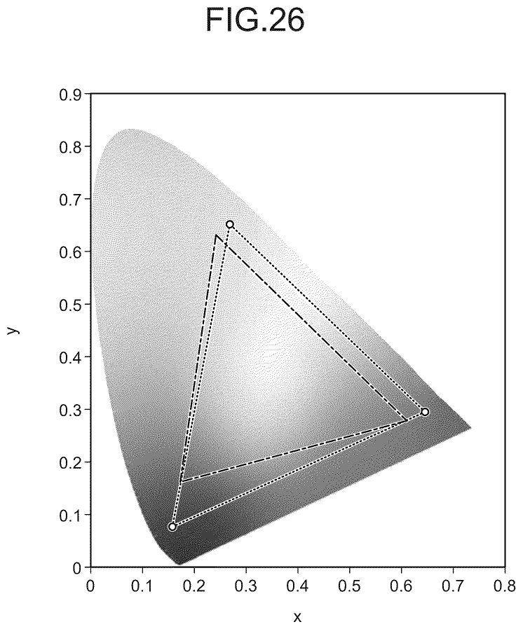

The color gamut of the second image displayed on the second image display panel 20 depends on the transmitted light transmitted through the color resists of the second color filter 23. FIG. 26 is a schematic diagram (chromaticity diagram) of an example of the color gamut of the second image when the second image is displayed on the second image display panel in the display device according to the second embodiment. The alternate long and short dash line in FIG. 26 indicates the color gamut of the second image transmitted through the second image display panel 20. The dotted line in FIG. 26 indicates the color gamut of the transmitted light of the first image display panel 10.

In the display device 1a according to the second embodiment, when the second image is displayed on the second image display panel, the color gamut of the transmitted light of the first image display panel 10 is smaller than that of the display device according to the comparative example. However, the color gamut of the second image displayed on the second image display panel 20 with the transmitted light of the first image display panel 10 is larger than that of the transmitted light of the first image display panel 10 as illustrated in FIG. 26, similarly to the display device 1 according to the first embodiment. In the configuration of the display device 1a according to the second embodiment, the thickness of the second color filter 23 in the Z-direction is less than that of the first color filter 13 in the Z-direction. Therefore, the luminance of the second image displayed on the second image display panel 20 can be increased. Specifically, the luminance of the second image displayed on the second image display panel 20 can be, for example, approximately 1.2 times the luminance of the configuration according to the comparative example.

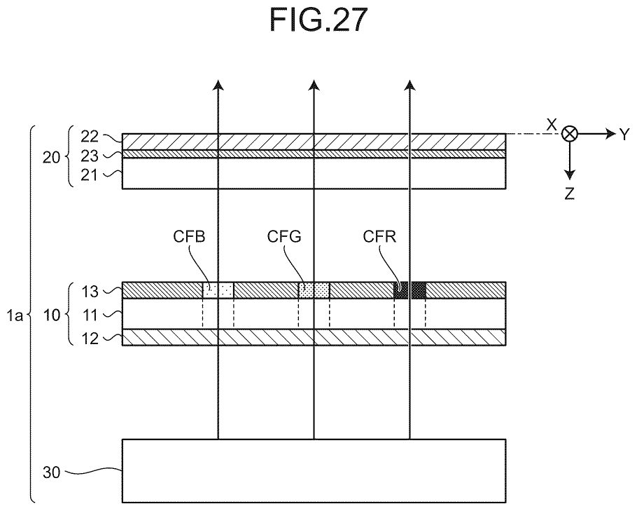

FIG. 27 is a diagram conceptually illustrating a state where the first image is displayed on the first image display panel in the display device according to the second embodiment. FIG. 27 illustrates the arrows indicating light rays passing through the red color resist CFR (first region) corresponding to the sub-pixel that reproduces red in the first image, the green color resist CFG (second region) corresponding to the sub-pixel that reproduces green in the first image, and the blue color resist CFB (third region) corresponding to the sub-pixel that reproduces blue in the first image.

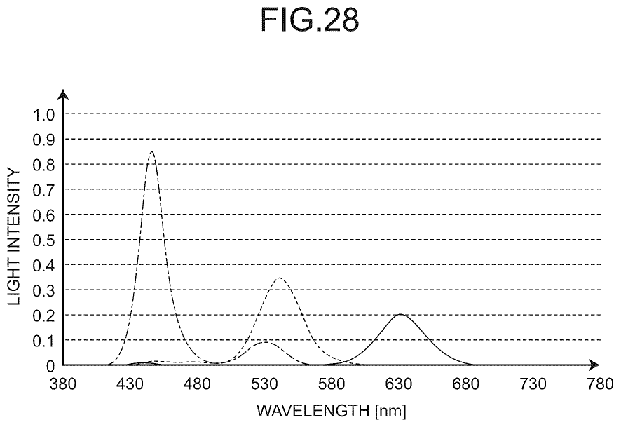

FIG. 28 is a graph of an example of the transmitted light spectrum of the first color filter in the display device according to the second embodiment. The horizontal axis in FIG. 28 indicates the wavelength, and the vertical axis indicates the light intensity (relative value) of the transmitted light of the first color filter. In FIG. 28, the solid line indicates the spectrum of light transmitted through the red color resist, the dashed line indicates the spectrum of light transmitted through the green color resist, and the alternate long and short dash line indicates the spectrum of light transmitted through the blue color resist. The peak value of each spectrum illustrated in FIG. 28 corresponds to the gradation values of the sub-pixels that reproduce the corresponding colors in the second image.

The first image displayed on the first image display panel 10 receives the output light from the backlight 30, illustrated in FIG. 9.

Light transmitted through the color resists of the first color filter 13 of the first image display panel 10 is incident on the color resists of the second color filter 23 of the second image display panel 20.

More specifically, light transmitted through the red color resist of the first color filter 13 of the first image display panel 10 is incident on each color resist of the second color filter 23 of the second image display panel 20. Light transmitted through the green color resist of the first color filter 13 of the first image display panel 10 is incident on each color resist of the second color filter 23 of the second image display panel 20. Light transmitted through the blue color resist of the first color filter 13 of the first image display panel 10 is incident on each color resist of the second color filter 23 of the second image display panel 20.

Specifically, for example, when red is displayed on the first image display panel 10, light transmitted through the red color resist of the first image display panel 10 is incident on the second image display panel 20. The red light incident on the second image display panel 20 is transmitted through each color resist of the second image display panel 20, and color composited by the light transmitted through the color resists of the second image display panel 20 is visually recognized by the viewer.

For example, when green is displayed on the first image display panel 10, light transmitted through the green color resist of the first image display panel 10 is incident on the second image display panel 20. The green light incident on the second image display panel 20 is transmitted through each color resist of the second image display panel 20, and color composited by the light transmitted through the color resists of the second image display panel 20 is visually recognized by the viewer.

For example, when blue is displayed on the first image display panel 10, light transmitted through the blue color resist of the first image display panel 10 is incident on the second image display panel 20. The blue light incident on the second image display panel 20 is transmitted through each color resist of the second image display panel 20, and color composited by the light transmitted through the color resists of the second image display panel 20 is visually recognized by the viewer.

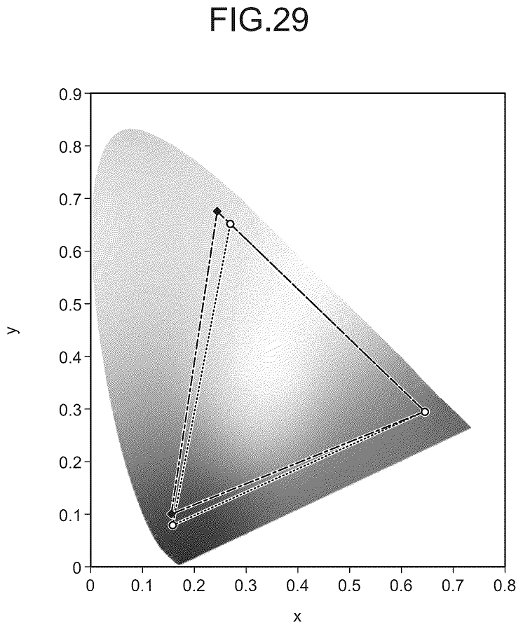

The color gamut of the first image displayed on the first image display panel 10 depends on the transmitted light transmitted through the color resists of the second color filter 23. FIG. 29 is a schematic diagram (chromaticity diagram) of an example of the color gamut of the first image when the first image is displayed on the first image display panel in the display device according to the second embodiment. The alternate long and short dash line in FIG. 29 indicates the color gamut of the first image transmitted through the second image display panel 20. The dotted line in FIG. 29 indicates the color gamut of the first image transmitted through the first image display panel 10.

In the display device 1a according to the second embodiment, when the first image is displayed on the first image display panel, the color gamut of the first image transmitted through the second image display panel 20 is not significantly different from that of the first image transmitted through the first image display panel 10 and is smaller than in the configuration of the display device according to the comparative example, as illustrated in FIG. 29, similarly to the display device 1 according to the first embodiment. Therefore, the color gamut of the second image indicated by the alternate long and short dash line in FIG. 26 is smaller than that of the first image indicated by the alternate long and short dash line in FIG. 29. Also in this case, the luminance of the first image displayed on the first image display panel 10 can be increased by making the thickness of the second color filter 23 in the Z-direction less than that of the first color filter 13 in the Z-direction. Specifically, the luminance of the first image displayed on the first image display panel 10 can be, for example, approximately 1.2 times the luminance of the configuration according to the comparative example.

As described above, in the display device 1a according to the second embodiment, the thickness of the second color filter 23 in the Z-direction is less than the thickness of the first color filter 13 in the Z-direction. This configuration can increase the quantity of light transmitted through the second color filter 23, thereby reducing the decrease in the quantity of transmitted light of the display device 1a.

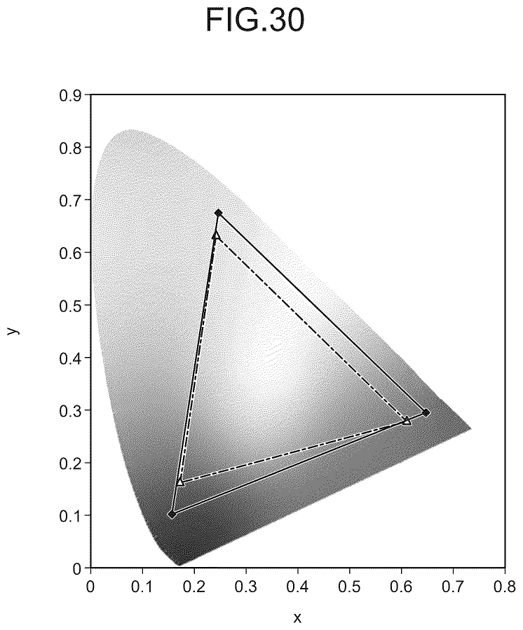

FIG. 30 is a first schematic diagram (chromaticity diagram) for comparing the color gamut of the display device according to the first embodiment with that of the display device according to the second embodiment. In the first schematic diagram illustrated in FIG. 30, the color gamuts when the second image is displayed on the second image display panel 20 are compared.

The solid line in FIG. 30 indicates the color gamut in the display device 1 according to the first embodiment (color gamut indicated by the solid line in FIG. 19). The color gamut in the display device 1 according to the first embodiment substantially matches the color gamut in the display device according to the comparative example (color gamut indicated by the solid line in FIG. 12).

The alternate long and short dash line in FIG. 30 indicates the color gamut in the display device 1a according to the second embodiment (color gamut indicated by the alternate long and short dash line in FIG. 26).

As illustrated in FIG. 30, when the second image is displayed on the second image display panel 20, the color gamut in the display device 1 according to the first embodiment indicated by the solid line is larger than that in the display device 1a according to the second embodiment indicated by the alternate long and short dash line.

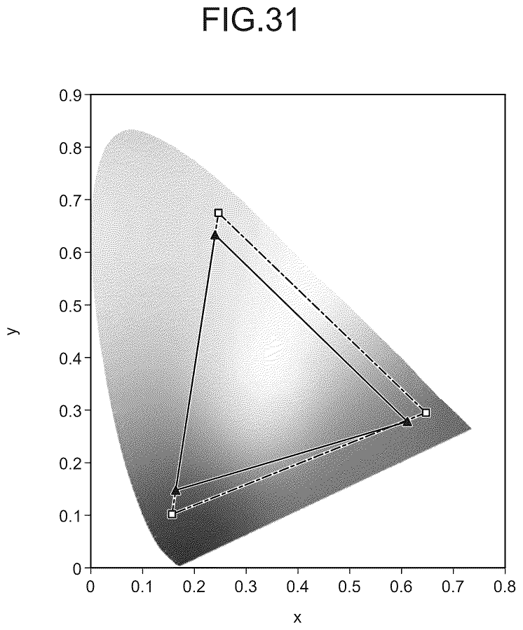

FIG. 31 is a second schematic diagram (chromaticity diagram) for comparing the color gamut of the display device according to the first embodiment with that of the display device according to the second embodiment. In the second schematic diagram illustrated in FIG. 31, the color gamuts when the first image is displayed on the first image display panel 10 are compared.

The solid line in FIG. 31 indicates the color gamut in the display device 1 according to the first embodiment (color gamut indicated by the solid line in FIG. 22).

The alternate long and short dash line in FIG. 31 indicates the color gamut in the display device 1a according to the second embodiment (color gamut indicated by the alternate long and short dash line in FIG. 29). The color gamut in the display device 1a according to the second embodiment substantially matches the color gamut in the display device according to the comparative example (color gamut indicated by the solid line in FIG. 15).

As illustrated in FIG. 31, when the first image is displayed on the first image display panel, the color gamut in the display device 1 according to the first embodiment indicated by the solid line is smaller than that in the display device 1a according to the second embodiment indicated by the alternate long and short dash line.

As described above, in the HUD 100 illustrated in FIG. 1, the virtual image VIR of the first image displayed on the first image display panel 10 is visually recognized by the viewer OB at a position farther in the direction indicated by the dashed arrow in FIG. 1 than the virtual image VIF of the second image displayed on the second image display panel 20. In other words, the virtual image VIR of the first image displayed on the first image display panel 10 is visually recognized as if it were behind the virtual image VIF of the second image displayed on the second image display panel 20.

It is desirable for such an aspect of the HUD 100 to have high color reproducibility of the virtual image VIF of the second image visually recognized in front. Therefore, the display device used in the HUD 100 of the aspect illustrated in FIG. 1 preferably has the configuration according to the first embodiment where the first color filter 13 is thinner than the second color filter 23 to make the color gamut of the first image by the first color filter 13 smaller, thereby reducing the decrease in the quantity of transmitted light of the display device 1.

While the thickness of the first color filter 13 according to the embodiments described above is different from that of the second color filter 23, the thickness of the red color resist (first region) of the first color filter 13 may be different from that of the red color resist (first region) of the second color filter 23. Alternatively, the thickness of the green color resist (second region) of the first color filter 13 may be different from that of the green color resist (second region) of the second color filter 23. Still alternatively, the thickness of the blue color resist (third region) of the first color filter 13 may be different from that of the blue color resist (third region) of the second color filter 23. The transmissible colors of the color resists provided to the first color filter 13 and the second color filter 23 are not limited to red (R), green (G), and blue (B) and may also include white (W), for example. The first color filter 13 and the second color filter 23 may be color filters of a complementary color system, such as white (W), cyan (C), magenta (M), yellow (Y), and green (G).

While the exemplary embodiments of the present disclosure have been described, the embodiments are not intended to limit the present disclosure. The contents disclosed in the embodiments are given by way of example only, and various modifications may be made without departing from the spirit of the present disclosure. For example, appropriate modifications made without departing from the spirit of the present disclosure naturally fall within the technical scope of the present invention.

What is claimed is:

1. A display device comprising:
a backlight;
a first image display panel configured to receive direct light from the backlight; and
a second image display panel disposed with a gap interposed between the second image display panel and the first image display panel and configured to receive light transmitted through the first image display panel, wherein
the first image display panel comprises:
a first polarizing plate configured to transmit light polarized in a first direction and block light polarized in a direction different from the first direction; and
a first color filter provided between at least the first polarizing plate and the second image display panel,
the second image display panel comprises:
a second polarizing plate configured to transmit light polarized in a second direction different from the first direction and block light polarized in a direction different from the second direction; and
a second color filter provided between at least the second polarizing plate and the first image display panel,
the thickness of the first color filter is different from the thickness of the second color filter, and
another polarizing plate is not provided between the first image display panel and the second image display panel.

2. The display device according to claim 1, wherein the first color filter is thinner than the second color filter.

3. The display device according to claim 1, wherein the second color filter is thinner than the first color filter.

4. The display device according to claim 1, wherein
the first color filter and the second color filter each have:
a first region configured to transmit first light and attenuate light having a wavelength other than at least the first light;
a second region configured to transmit second light having a wavelength different from the first light and attenuate light having a wavelength other than at least the second light; and
a third region configured to transmit third light having a wavelength different from the first light and the second light and attenuate light having a wavelength other than at least the third light.

5. The display device according to claim 4, wherein the thickness of the first region of the first color filter is less than the thickness of the first region of the second color filter.

6. The display device according to claim 4, wherein the thickness of the second region of the first color filter is less than the thickness of the second region of the second color filter.

7. The display device according to claim 4, wherein the thickness of the third region of the first color filter is less than the thickness of the third region of the second color filter.

8. The display device according to claim 4, wherein the thickness of the first region of the second color filter is less than the thickness of the first region of the first color filter.

9. The display device according to claim 4, wherein the thickness of the second region of the second color filter is less than the thickness of the second region of the first color filter.

10. The display device according to claim 4, wherein the thickness of the third region of the second color filter is less than the thickness of the third region of the first color filter.

11. The display device according to claim 1, wherein an image output region of the first image display panel and an image output region of the second image display panel overlap when viewed in a direction of a line of sight of a viewer.

12. The display device according to claim 11, wherein a distance from a point of view of the viewer to a first image displayed on the first image display panel is farther than a distance from the point of view of the viewer to a second image displayed on the second image display panel.

13. The display device according to claim 12, wherein the first image and the second image are superimposed on each other in the direction of the line of sight of the viewer.

14. The display device according to claim 13, wherein a first object displayed on the first image display panel and a second object displayed on the second image display panel are superimposed on each other in the direction of the line of sight of the viewer to form one composite object.

15. A head-up display configured to allow an image reflected by a light-transmitting member configured to transmit and reflect incident light to be visually recognized as a virtual image by a viewer in such a manner that the virtual image is superimposed on a real image transmitted through the light-transmitting member, the head-up display comprising:
the display device according to claim 11; and
a magnifying optical system configured to magnify an image displayed on the display device and project the magnified image onto the light-transmitting member.
